(19) United States
(12) Patent Application Publication
(10) Pub. No.: US 2024/0092031 A1
(43) Pub. Date: Mar. 21, 2024

(54) TOPOGRAPHIC COMPENSATION FOR A THREE-DIMENSIONAL DUAL PRINTER HEAD PRINTER

(71) Applicant: Essentium IPCO, LLC, Pflugerville, TX (US)

(72) Inventors: Alexis Ehrlich, Costa Mesa, CA (US); William Jack MacNeish, III, Santa Ana, CA (US); Jorge Arturo Mijares Tobias, Puebla (MX)

(21) Appl. No.: 18/495,107

(22) Filed: Oct. 26, 2023

Related U.S. Application Data
(63) Continuation of application No. PCT/US22/26724, filed on Apr. 28, 2022.
(60) Provisional application No. 63/180,998, filed on Apr. 28, 2021.

(51) Int. Cl. B29C 64/393; B29C 64/245

(52) U.S. Cl. CPC B29C 64/393; B29C 64/245; B33Y 50/02

(57) ABSTRACT

A method and three-dimensional printer for compensating for build surface topography. The printer including a controller including executable code to carry out the method of measuring a position of a build surface in a z-axis at a number of points on the build surface when the build surface is pressed against a fixed point on a print head, fitting an x, y-plane to at least three of the number of points on the build surface, leveling the build surface by rotating the x, y-plane around the point of origin in the z-axis, creating a topographic compensation map based on the position of the build surface measured at the number of points on the build surface, and adjusting the distance between the fixed point on the first print head and the build surface during printing referencing the topographic compensation map.

### CROSS REFERENCE TO RELATED APPLICATIONS

The present application claims the benefit of the filing date of U.S. Provisional Application No. 63/180,998 filed on Apr. 28, 2021, the teachings of which are incorporated herein by reference.

### FIELD

The present disclosure is directed to topographic compensation for a three-dimensional printer with independent dual printer heads.

### BACKGROUND

In extrusion based additive manufacturing processes, the build plate and support bed upon which the filament is extruded upon is an important factor in successfully printing a three-dimensional part as the first layer builds off the build surface and the next layers build off the previously deposited layer. An unlevel surface and lack of flatness, due to surface roughness, waviness, or warping, imparts aberrations in the printed component, some which become amplified as the number of printed layers increase. Often leveling of the support bed can be mechanically adjusted, but in many instances, flatness is an immutable characteristic of a build surface unless a different build surface is supplied, or the build surface is altered. Build surfaces are formed from various materials, such as glass, polymers, metals and metal alloys, or composites, and by a number of manufacturing processes. Glass surfaces, such as float glass, may be relatively flat, whereas polymer sheets are compliant but are relatively less flat than glass. Some support beds may exhibit a deviation of up to a few millimeters across the surface of the bed. Further, the use of certain build surfaces is sometimes dictated by the material that is being extruded in the additive manufacturing process.

While it is possible to change out a build surface for another build surface having a higher degree of surface flatness, this may not always be possible. Another method used to compensate for reduced flatness of the build surface includes using a sensor in the print head to measure the distance, in the z-axis, between the print head and the build surface at various points across the build surface and then adjusting the distance between the print head and the build surface during printing by raising or lowering the build surface or print head. However, adding a second print head complicates the adjustment, particularly for true independent dual head extruder systems where the print heads move in at least one axis on separate carriages, as the z-axis adjustment for one print head may negatively impact the adjustment for the other print head.

Thus, while current compensation systems and methods achieve their intended purpose, there remains room for the development of new and improved systems and methods for compensating for support bed surface aberrations.

### SUMMARY

Aspects of the present disclosure relate to a method of compensating for build surface topography. The method includes measuring a position of a build surface in a z-axis at a number of points on the build surface when the build surface is pressed against a fixed point on a print head; fitting an x, y-plane to at least three of the number of points on the build surface; leveling the build surface by rotating the x, y-plane around the point of origin in the z-axis; creating a topographic compensation map based on the position of the build surface measured at the number of points on the build surface; and adjusting a distance between a fixed point on the first print head and the build surface during printing referencing the topographic compensation map.

Aspects of the present disclosure further relate to a method of compensating for build surface topography. The method includes measuring a position of a build surface in a z-axis at each point in a first set of points on the build surface when the build surface is pressed against a first fixed point on a first print head. The method further includes fitting an x, y-plane to the first set of points on the build surface, leveling the build surface by rotating the x, y-plane around a point of origin in the z-axis, creating a first topographic compensation map based on a second set of points on the build surface, and adjusting a distance between the first fixed point on the first print head and the build surface during printing referencing the first topographic compensation map.

In any of the above aspects, measuring includes raising the build surface until the build surface touches a first extrusion nozzle in the first print head at each of the points in the first set of points on the build surface, raising the first extrusion nozzle to contact a first sensor placed on the first print head, and measuring the position (Dz) of the build surface in the z-axis relative to a starting point in the z-axis.

In further aspects, the build surface is supported by a z-axis gantry connected to a z-axis linear adjustment drive and leveling comprises calculating an offset for the z-axis linear adjustment drive and applying the offset to the z-axis linear adjustment drive.

In further aspects of the above, the z-axis gantry is connected to three z-axis linear adjustment drives and leveling comprises calculating an offset for each of the three z-axis linear adjustment drives.

In further aspects of the above, the method further includes measuring and leveling until each of the offsets for the z-axis linear adjustment drives is under a threshold.

In any of the above aspects, creating the first topographic compensation map includes measuring the position of the build surface in the z-axis at each of the second set of points on the build surface when the build surface is pressed against a first fixed point on the first print head.

In further aspects of the above, measuring includes raising the build surface until the build surface touches a first extrusion nozzle in the first print head at each of the points in the second set of points on the build surface, raising the first extrusion nozzle to contact a first sensor, and measuring the position (Dz) of the build surface in the z-axis relative to a starting point in the z-axis.

In further aspects of the above, the second set of points includes the first set of points.

In any of the aspects above, the method includes creating a second topographic compensation map for a second print head.

In further aspects, creating the second topographic compensation map includes measuring a position of the build surface in the z-axis at the second set of points on the build surface when the build surface is pressed against a second fixed point on the second print head.

Additional aspects of the present disclosure relate to a three-dimensional printer. The three-dimensional printer includes a controller. The controller includes executable code to measure a position of the build surface at a number of points on the build surface, fit an x, y-plane to at least three of the number of points on the build surface, level the build surface by rotating the x, y-plane around the point of origin in the z-axis, create a topographic compensation map based on the position of the build surface measured at the number of points on the build surface; and adjust the distance between the fixed point on the first print head and the build surface during printing referencing the topographic compensation map.

Aspects of the present disclosure further relate to a three-dimensional printer. The three-dimensional printer includes a controller. The controller includes executable code to measure a position of a build surface in a z-axis at each point in a first set of points on the build surface when the build surface is pressed against a fixed point on a first print head. The controller further includes executable code to fit an x, y-plane to the first set of points on the build surface, level the build surface by rotating the x, y-plane around a point of origin in the z-axis, create a first topographic compensation map based on a second set of points on the build surface, and adjust a distance between the fixed point on the first print head and the build surface during printing referencing the first topographic compensation map.

In aspects of the above, to measure the controller includes executable code to raise the build surface until the build surface touches a first extrusion nozzle in the first print head at each of the points in the first set of points on the build surface, raise the first extrusion nozzle to contact a first sensor placed on the first print head, and measure the position (Dz) of the build surface in the z-axis relative to a starting point in the z-axis.

In further aspects of the above, the build surface is supported by a z-axis gantry connected to a z-axis linear adjustment drive. To level the build surface the controller includes executable code to calculate an offset for the z-axis linear adjustment drive and apply the offset to the z-axis linear adjustment drive.

In further aspects of the above, the z-axis gantry is connected to three z-axis linear adjustment drives and to level the build surface the controller includes executable code to calculate an offset for each of the three z-axis linear adjustment drives.

In further aspects of the above, the controller includes further executable code to repeat measuring and leveling until each offset for the z-axis linear adjustment drives is under a threshold.

In any of the above aspects, to create the first topographic compensation map the controller includes executable code to measure the position of the build surface in the z-axis at each of the second set of points on the build surface when the build surface is pressed against a first fixed point on the first print head.

In further aspects of the above, to measure the position of the build surfaces in the z-axis at each of the second set of points on the build surface the controller includes executable code to, raise the build surface until the build surface touches a first extrusion nozzle in the first print head at each of the points in the second set of points on the build surface, raise the first extrusion nozzle to contact a first senso, and measure the position (Dz) of the build surface in the z-axis relative to a starting point in the z-axis.

In further aspects of the above, the second set of points includes the first set of points.

In any of the above aspects, the controller includes further executable code to create a second topographic compensation map for a second print head.

In further aspects of the above, to create the second topographic compensation map the controller includes instructions to measure a position of the build surface in the z-axis at the second set of points on the build surface when the build surface is pressed against a second fixed point on the second print head.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 illustrates a schematic of an embodiment of a three-dimensional printer;

FIG. 2 illustrates a cross-section of an embodiment of a support bed including a build surface;

FIG. 3 illustrates an embodiment of a z-axis gantry in a lower printer frame;

FIG. 4 illustrates an embodiment of an upper printer frame including two print heads mounted on print head gantries;

FIG. 5 illustrates the print head including a sensor associated with the extrusion nozzle;

FIG. 6 illustrates an embodiment of a controller for a three-dimensional printer;

FIG. 7 illustrates an embodiment of a method of leveling and compensating for topographic aberrations in a three-dimensional printer;

FIG. 8a illustrates an example of measurement points for leveling the build surface of a three-dimensional printer;

FIG. 8b illustrates an example of measurement points for leveling the build surface of a three-dimensional printer;

FIG. 9 illustrates an example of measurement points for creating a topographic compensation map of the build surface of a three-dimensional printer;

FIG. 10 illustrates an embodiment of a method of leveling and compensating for topographic aberrations in a three-dimensional printer;

FIG. 11a illustrates an embodiment of a build surface that is out of level relative to a coordinate frame, i.e., a series of x, y, z coordinates (referenced as printer coordinate frame), of the print head;

FIG. 11b illustrates an embodiment of a build surface after it has been leveled relative to the coordinate frame of the print head (referenced as printer coordinate frame);

FIG. 11c illustrates an embodiment of a build surface after the offset of the topographic compensation map has been applied, in the form of an offset in the z-axis;

FIG. 12 illustrates an embodiment of a method of leveling and compensating for topographic aberrations in a three-dimensional printer;

FIG. 13a illustrates an embodiment of a build surface after measurements of position Dz have been taken to provide a coordinate frame, i.e., the series of x, y, z coordinates measured at the various points and an x, y-plane of the build surface has been fit from a number of the measured x, y, z, coordinates;

FIG. 13b illustrate an embodiment of the build surface after the coordinate frame has been translated to the primary z-axis linear adjustment drive;

FIG. 13c illustrates an embodiment of the build surface after the coordinate frame the coordinate frame has been transformed by rotation of the coordinate frame to be co-planar with the x, y-plane defined by the build surface;

FIG. 13d illustrates an embodiment of the coordinate frame being translated to the local x-axis origin of the printer frame, i.e., the series of x, y, z-coordinates of the print head measured when measuring the coordinates of the coordinate frame; and

FIG. 13e illustrates an embodiment of the build surface after it has been leveled and the transformation of the sampled points are in the printer coordinate frame.

The drawings described herein are for illustration purposes and are not intended to limit the scope of the present disclosure in anyway.

### DETAILED DESCRIPTION

The present disclosure is directed to topographic compensation for a three-dimensional printer with independent dual printer heads, including a three-dimensional printer and method for leveling and compensating for topographic aberrations in the build surface.

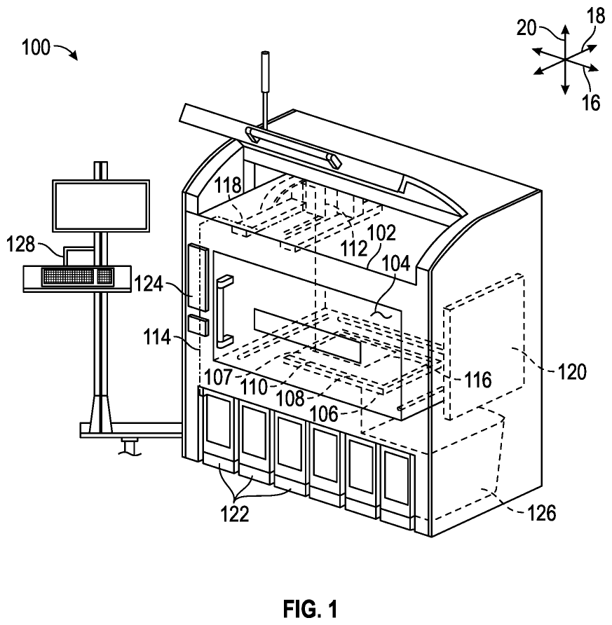

An aspect of a three-dimensional printer is illustrated in FIG. 1. The three-dimensional printer 100 generally includes an enclosure 102 defining a process chamber 104 and a support bed 106 including a build surface 107 is supported within the process chamber 104. In the illustrated aspect, the support bed 106 includes a support surface 108 onto which a build plate 110 is placed, wherein the build plate 110 includes a build surface. The three-dimensional printer 100 further includes two print heads 112 (only one of which is illustrated in FIG. 1) that deposit filament 114 onto the build plate 110 to form the three-dimensionally printed object 116. It should be appreciated that, in aspects, a single print head 112 is present. The print heads 112 are each supported relative to the build plate 110 on an x, y-axis gantry 118, which provide motion along x,y-axes 16, 18. The support bed 106 is moved in the z-axis 20 relative to the print head 112 by a z-axis gantry 120, moving along z-axis 20. In further aspects, the print heads 112 may be moved in the z-axis 20 and the support bed 106 may be moved in the x, y-axes 16,18. Filament 114 is stored in one or more canisters 122 and provided to the print head 112 by a filament drive system 124. A vacuum system 126 is provided to secure the build plate 110 to the support bed 106. A controller 128 is provided to control the various functions of the three-dimensional printer 100.

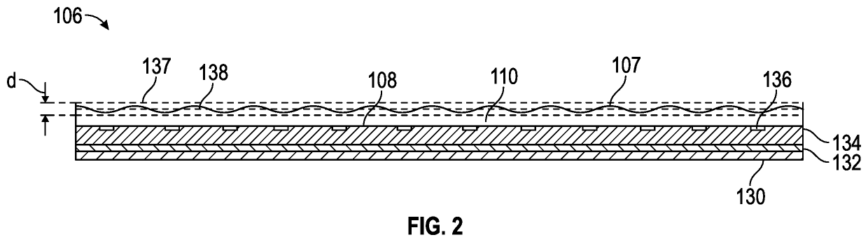

The support bed 106 is generally rectangular in shape, as illustrated in FIG. 1, but may assume alternate geometries, such as circular, oval, or square. In the aspect illustrated in FIG. 2, the support bed 106 including a build surface 107. The support bed 106 is formed from one or more layers 130, 132, 134. In the aspect illustrated, a heated layer 132, including one or more heating elements, is sandwiched between a composite layer 130 and a plate 134. The composite layer 130 includes, for example, a fiberglass-epoxy laminate composite or carbon fiber-epoxy laminate. The plate 134 provides a support surface 108. The plate 134 includes, for example, stainless steel, aluminum, or an aluminum alloy. Further, in aspects, the support surface 108 of the plate 134 exhibits a flatness in the range of 0.00 mm to 3.00 mm, including all values and ranges therein, over the entire length and width of the plate, including all values and ranges therein, regardless of any other features such as the grooves 136 defined in the support surface 108. In this aspect, a build plate 110 is placed on the support surface 108 and is retained against the support surface 108 by the application of vacuum applied through vacuum ports located at points in the grooves 136. The build plate 110 provides a build surface 107; however, it should be appreciated that in alternative aspects, the support surface 108 provides the build surface 107. In aspects, the build plate 110 is formed from materials such as polycarbonate, polypropylene, glass, spring steel, stainless steel, aluminum alloys. The build surface 107 is not completely flat and exhibits a number of aberrations 137, such as waviness, warping, or surface roughness. These aberrations cause a deviation d from an x,y-plane 138 generally defined by the build surface 107. As illustrated, the x,y-plane 138 is defined by the minimization of distance between the measured points and the plane. However, the x,y-plane 138 defined by the build surface 107 may alternatively be defined by utilizing other mathematical functions.

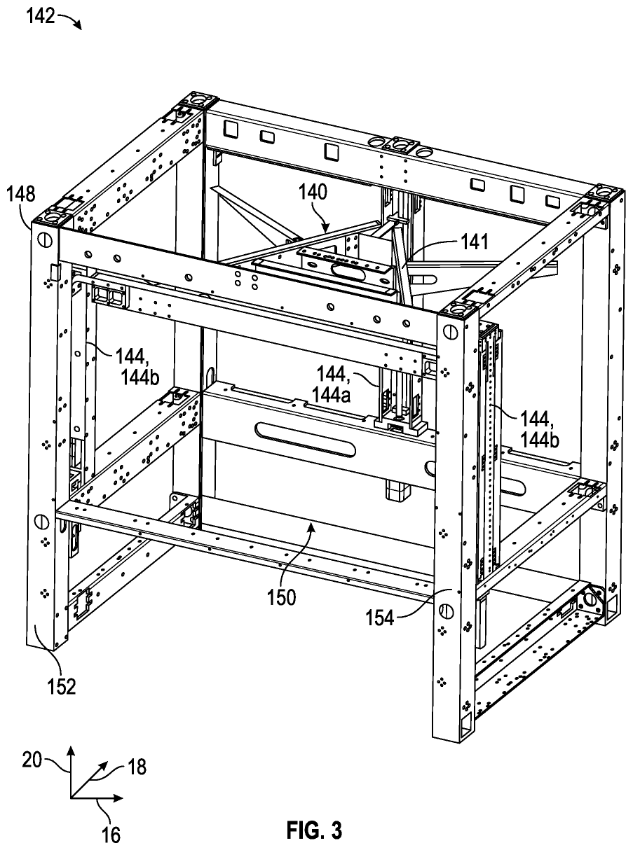

The support bed 106 is supported within the three-dimensional printer using a z-axis gantry 140, integrated in the lower frame 142 of the three-dimensional printer 100, an aspect of which is illustrated in FIG. 3. The z-axis gantry 140 includes a gantry table 141 for supporting the support bed 106. The gantry table 141 is connected to at least one z-axis linear adjustment drive 144 and, preferably, three linear adjustment drives 144, wherein a primary z-axis linear adjustment drive 144a is arranged at the rear 146 of the lower frame 142 and the other two z-axis linear adjustment drives 144b are arranged at the front 148 of the lower frame 142 on either side 152, 154 of an access opening 150. However, it should be appreciated that in some aspects, two z-axis linear adjustment drives 144 or more than three z-axis linear adjustment drives 144 may be present. While in the illustrated aspect includes a ball screw assembly, in alternative aspects, other linear drives may be used, such as a roller screw or an acme screw assembly. The z-axis linear adjustment drives 144 raise and lower the support bed 106 relative to the print heads 112, up and down in the direction of z-axis 20.

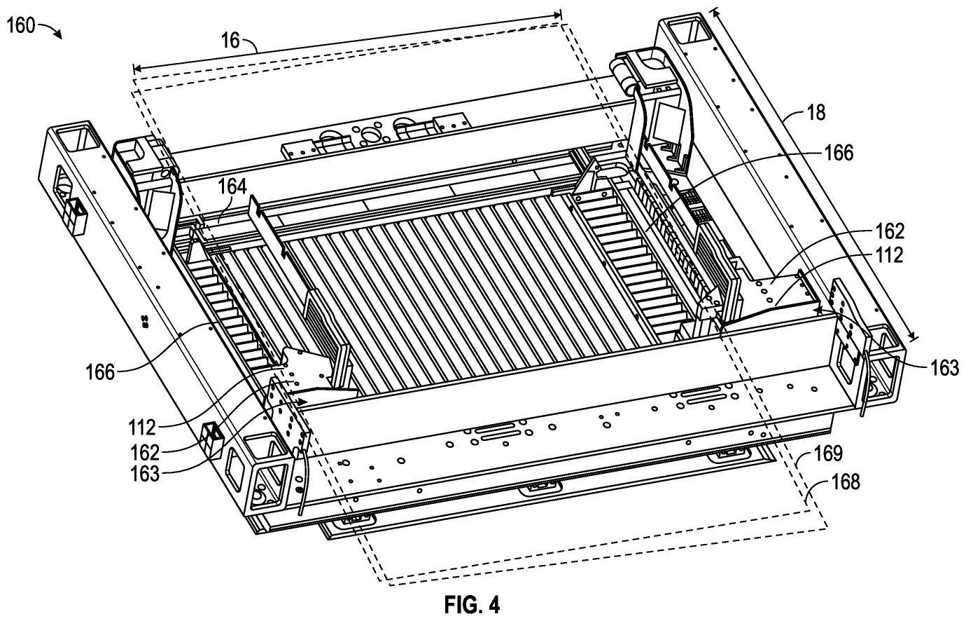

Reference is made to FIG. 4, which illustrates the print heads 112 positioned in the upper frame 160 of the three-dimensional printer 100, which is secured to the lower frame 142. The print heads 112 are supported by gantries 162. The gantries 162 are configured to move along parallel support rails 164 (a second support rail, not visible, is provided opposite from the first support rail 164 in the upper frame 160) in the x-axis 16, driven by a linear motor or other drive mechanism. Further, the print heads 112 are each configured to move back and forth along the y-axis 18 in a support frame 166 provided by each gantry 162, again propelled by a linear motor or other drive mechanism. The x-axis 16 being co-planar and perpendicular to the y-axis 18 and providing movement in an x-y, plane 168, 168 for each print head 112. However, it should be appreciated that as each print head 112 is mounted in a separate support frame 166, there may be some degree of deviation between the x-y planes 168, 169 each print head 112 travels in. In aspects, the deviation between the x-y plane 168, 169 of each print head 112 is up to six degrees, including all values and ranges therein.

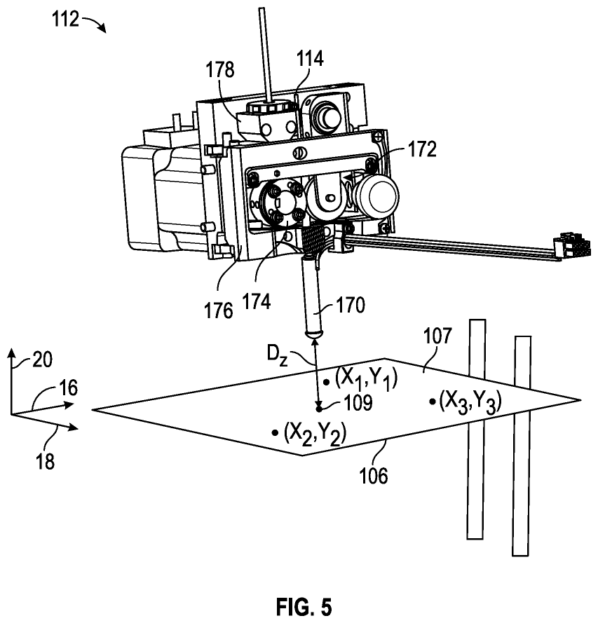

An aspect of a print head 112 is illustrated in FIG. 5. The print head 112 includes an extrusion nozzle 170, which is often heated. The print head 112 further includes a feed assembly 172, which includes one or more feed hobs 174 that feed the filament 114 into the extrusion nozzle 170. The extrusion nozzle 170 travels in the z-axis 20 in a frame 176, which the extrusion nozzle 170 is coupled to. A sensor 178 interacts with the extrusion nozzle 170 by way of the frame 176 in the illustrated aspect. However, it may be appreciated that the sensor 178 may alternatively be placed elsewhere in the print head 112, provided that it is capable to detect and, in further aspects, measure travel of the extrusion nozzle 170 in the z-axis 20. The sensor 178 is, in aspects, at least one of a contact sensor, such as a mechanical push button sensor, or a non-contact sensor, such as a capacitive displacement sensor, an inductive sensor, a magneto-inductive sensor, a laser sensor, and an optical sensor. When the support bed 106 is raised, the build surface 107 touches the extrusion nozzle 170, which causes the extrusion nozzle 170 to rise in the z-axis 20 and contact the sensor 178. When the sensor is contacted, the position of the build surface 107 is measured relative to a given point in the z-axis 20.

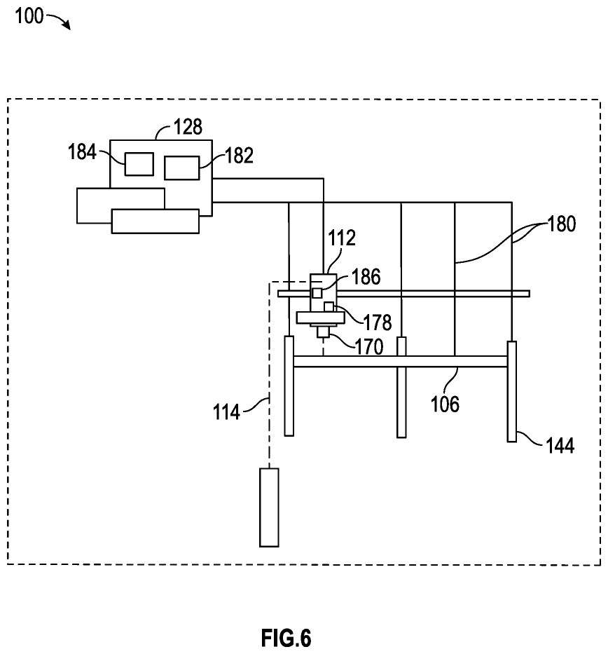

FIG. 6 illustrates the controller 128, which is connected to the print head 112, including the sensor 178, the drive motors 186, and the extrusion nozzle 170; the support bed 106, if heated or otherwise functionalized; and the z-axis linear adjustment drives 144. The connections are electrical connections facilitated by conductive wires 180 or wireless connections facilitated by radio frequency or optical communication protocols. The controller 128 includes one or more processors 182, such as microprocessors, that execute executable code to control the various functions of the three-dimensional printer 100, including the methods further described herein. The executable code is stored in a non-transient memory device 184 accessible to the controller 128, such as random-access memory, read only memory, non-volatile memory, such as flash memory, erasable programmable read only memory, electrically erasable programmable read only memory, digital versatile discs, and compact discs. In aspects, the executable code includes initialization protocols as well as g-code and m-code used in printing a three-dimensional object 116 (see FIG. 1). In aspects, the m-code is used to select and run each print head 112, whereas the g-code includes the movements used to print the three-dimensional object 116.

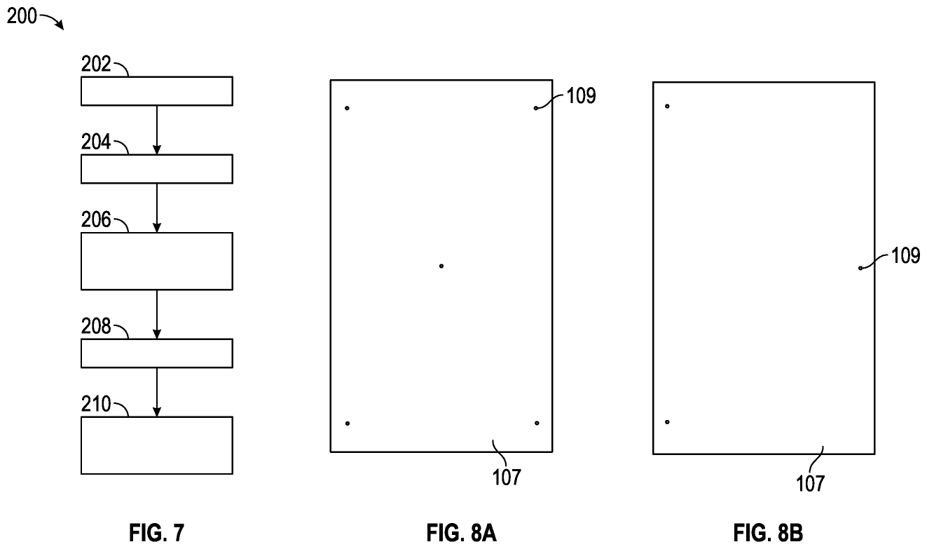

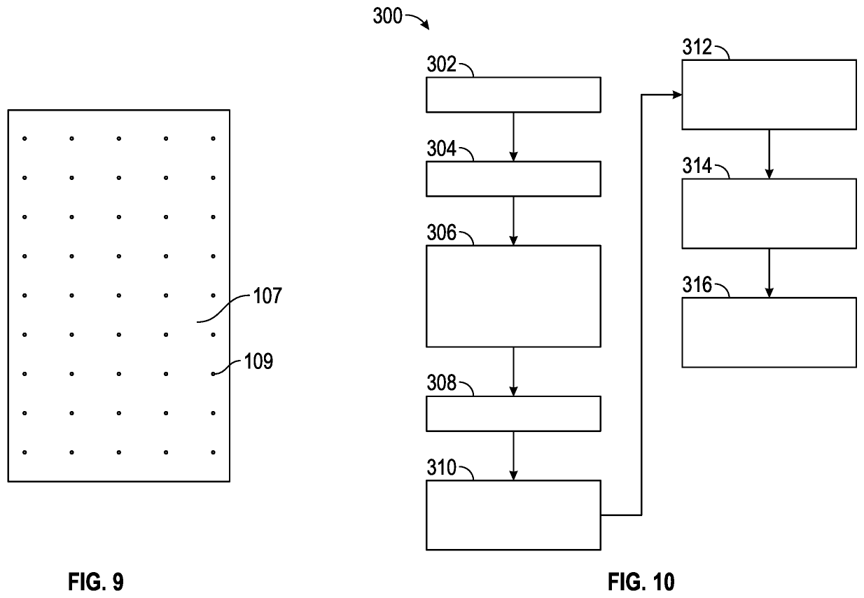

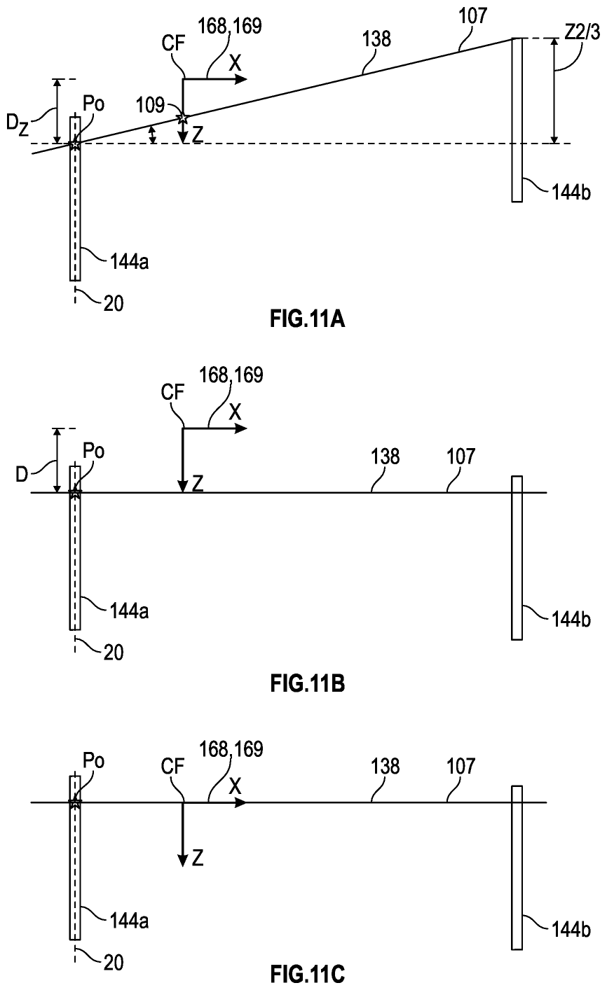

With reference again to FIGS. 1 through 6, when the support bed 106, or build plate 110, providing the build surface 107, is placed into the three-dimensional printer 100, the x-y plane defined by the build surface 107 may not be parallel with the x-y plane defined by each print head 112. Further, as noted above, the build surface 107 deviates from being completely flat and exhibits topographical aberrations. To improve the parallelism between build surface 107 and the x,y-planes 168, 169 defined by each print head 112, as well as compensate for the topographical aberrations of the build surface 107, and with reference to FIG. 7, a method 200 of leveling the build surface 107 and compensating for the topographical aberrations in the build surface 107 begins at block 202 by measuring a position of the build surface 107 in the z-axis 20, when the build surface touches the extrusion nozzle 170 and triggers sensor. The build surface 107 is moved up relative to the extrusion nozzle 170, from a starting point in the z-axis 20, and a position Dz of the build surface 107 in the z-axis 20 is taken when the build surface 107 presses against the extrusion nozzle 170 and triggers the sensor 178. It should be appreciated that in other configurations, where the print head 112 may move in the z-axis 20, the print head 112 may be moved relative to the build surface 107, or both the print head 112 and the build surface 107 may move relative to each other. The measurement of position Dz is repeated at various points 109 across the build surface 107, such as illustrated in FIGS. 8a and 8b as well as FIG. 9 to obtain a first set of measurements for leveling the build surface 107. A few of the measurements of position Dz are made for the purposes of calculating the initial x, y-plane 138 of the build surface 107. Anywhere between three measurements of position Dz and N number of measurements of position Dz may be taken as a first set of measurements of position Dz for leveling the build surface 107, including all values and ranges therein such as 3, 5, 10, 3 to 10, 3 to 5, etc. As illustrated in FIG. 8a, in aspects, five measurements of position Dz are taken points 109, four at the corners of the build surface and one at the center of the build surface 107. As illustrated in FIG. 8b, in other aspects, as few as three measurements of position Dz are taken at three points 109 near the perimeter of the build surface 107.

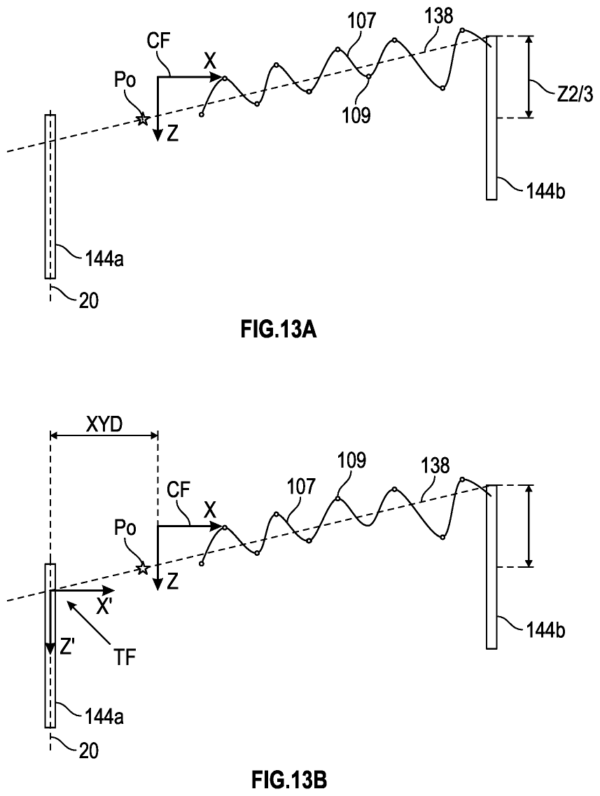

At block 204, the initial x, y plane 138 is then calculated using, for example, a least square fitting method. Then the build surface 107 is then leveled by calculating offsets (see, e.g., Z2/3 of FIG. 11a) for the z-axis linear adjustment drives 144b and applying the offsets to the z-axis linear adjustment drives 144b. The offsets Z2/3 is the amount that the z-axis linear adjustment drives 144 must be adjust in the z-axis 20 to level the build surface 107. The leveling process is repeated until the measurements of position Dz are under a threshold value.

At block 206, a topographic compensation map of the build surface 107 is then created, wherein a second set of z-axis measurements of position Dz are taken at numerous points 109, as described above, across the build surface 107 as illustrated in FIG. 9. This second set of measurements may be performed at the same time as the first set of measurements and may include the first set of measurements. While the points 109 for measuring position Dz are illustrated as being in a particular pattern in FIG. 9, it should be appreciated that other patterns or random points 109 for measuring position Dz may be taken. It should also be appreciated that the more points 109 that are measured, the longer the process of preparing a topographic compensation map will take and, therefore, in some aspects, interpolation of the measurements of position Dz between the extrusion nozzle 170 and the build surface 107 may be performed to predict the position Dz between the extrusion nozzle 170 and the build surface 107 between the points 109 measurements of position Dz. Block 206 is then repeated for the second print head 112, if present. Again, as may be appreciated, due to the slight variation between the x, y-planes 168, 169 of each print head 112, the topographic compensation map may differ between the print heads 112. The user or the controller 128 selects the print head 112 that will perform a printing operation at block 208 and the controller 128, based on the print head 112 selection, inserts the appropriate topographic compensation map to use during printing. The topographic compensation map, in aspects, is stored in memory, and includes the measurements of position Dz taken at points 109 across the build surface 107. It should be appreciated that points 109 used in the topographic compensation map for compensating for the build surface 107 topography include reference to x,y coordinates on the build surface 107 after the build surface 107 has been leveled.

Then, at block 210, during printing the distance between the build surface 107 and extrusion nozzle 170 or other fixed point on the print head 112, is adjusted, based on the measurements of position Dz at points 109 across the build surface 107, to maintain a relatively consistent distance between the build surface 107 and extrusion nozzle 170 during printing. If two printer heads 112 are, at block 210, printing simultaneously, then in aspects, the topographic compensation maps for each print head 112, may be simultaneous referenced and the distance between the build surface 107 and extrusion nozzles 170 may be adjusted based on an average of the two distance measurements for each print head 112 at a given time point in the printing process.

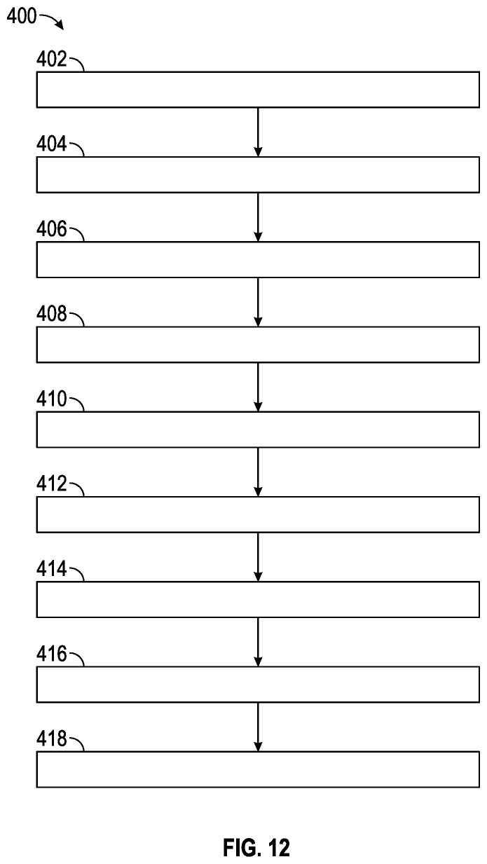

FIG. 10, with further reference to FIGS. 11a through 11c, further illustrates a method 300 of leveling a build surface 107 and compensating for topographical aberrations in the build surface 107 for a three-dimensional printer including two print heads 112. The method 300 includes at block 302 taking a first set of measurements of position Dz at certain points 109 around the build surface 107, such as those illustrated in FIGS. 8a and 8b, for leveling the build surface 107. Again, in aspects, from three to ten points across the build surface are measured. Once the leveling points 109 are sampled and the measurements of position Dz taken, at block 304, an x, y-plane 138 for the build surface 107 is fit to the points 109 using, for example, least squares fitting as illustrated in FIG. 11a.

At block 306, calculations are performed to determine the offsets Z2/3 and how much each z-axis linear adjustment drive 144, and in particular aspects the secondary z-axis linear adjustment drives 144b are to be adjusted so that the initial x, y-plane 138 defined by the build surface 107 is parallel to, or substantially parallel to, the x, y plane 168, 169 of the print head 112. At block 308, the calculated offset is applied and the build surface 107 is moved or rotated around a point of origin Po, illustrated in FIG. 11b, defined by the intersection of the initial x, y-plane 138 of build surface 107 and the z-axis 20 defined by a primary z-axis linear adjustment drive 144a, by adjusting secondary z-axis linear adjustment drives 144b. Then at 310, new measurements of position Dz are taken at the same, or different points 109, and the process of leveling is repeated until the calculated offset for each z-axis linear adjustment drive 144 is below a given threshold. At block 312, a second set of measurements of position Dz are taken at a number of points 109 across the build surface 107 for the purposes of determining topographic aberrations. This process, beginning, at block 312, and in alternative aspects at block 302, is then repeated for the second print head 112. The topographic compensation maps are saved in a memory device 184 and when it is time to print and a print head 112 is selected for printing, the processor 182 selects the topographic compensation map stored for that print head 112. The relative distance between the build surface 107 and the extrusion nozzle 170 is then adjusted, based on the topographic compensation map, to maintain a consistent distance between the build surface 107 and the extrusion nozzle 170 during printing as illustrated in FIG. 11c.

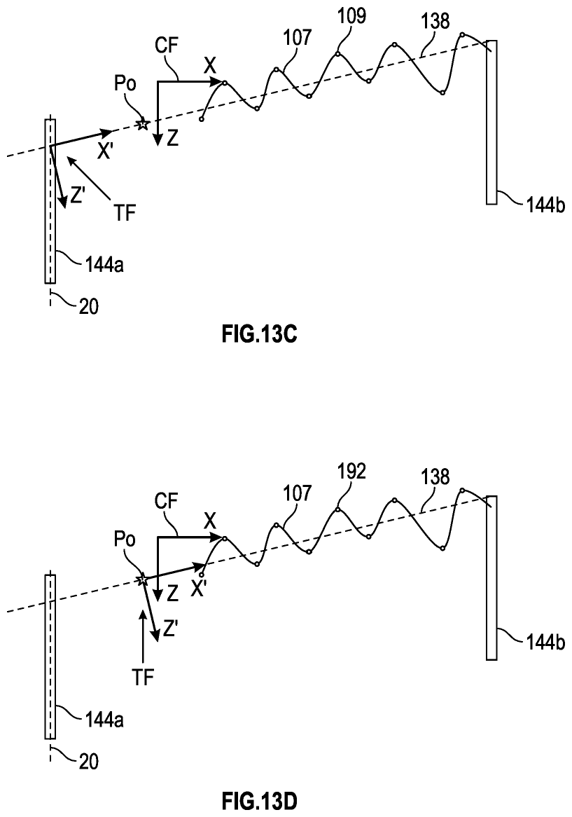

FIG. 12 illustrates a further method 400 for leveling the build surface 107 and compensating for topographical aberrations in the build surface 107. This method 400 combines taking of the first set of measurements of position Dz and the second set of measurements of position Dz all at once, in a single step. Further, in this method a number of transforms are performed to the x, y, z measurements of position Dz taken at various points 109 on the unleveled build surface 107. This dataset is manipulated such that the measurements of position Dz at points 109 are transformed, into a coordinate frame TF, with the x,y-plane of the coordinate frame CF co-planar to the x,y-plane 138 defined by the build surface 107. Further, the point of origin Po of the coordinate frame CF, also referred to and understood as the origin of the coordinate frame CF, is selected based on the predicted value of the extrusion nozzle 170 in the x,y-plane 168, 169 when the print head 112 is located as far as possible against a given corner 163 of the upper frame 160, assuming a level build surface 107. In alternative aspects, an alternative point of origin Po may be selected. It should also be appreciated that, as the levelness of the build surface 107 is altered, the point of origin Po moves relative to the coordinate frame CF, but not relative to the build surface 107. To arrive at the transformed coordinate frame TF, a series of transforms, using known values from the physical system are concatenated and the data set, provided by the measurements of position Dz at points 109, are transformed from the origin coordinate frame CF to the transformed coordinate frame TF. The transforms include intersecting the x, y-plane 138 of the build surface 107 with a z-axis 20 defined by the primary z-axis linear adjustment drive 144a, rotating the coordinate frame so the z-axis 20 is perpendicular to the x, y-plane 138, and translating the coordinate frame in local x-axis distance from the z-axis 20 defined by the primary z-axis linear adjustment drive 144a to point of origin of the printer frame.

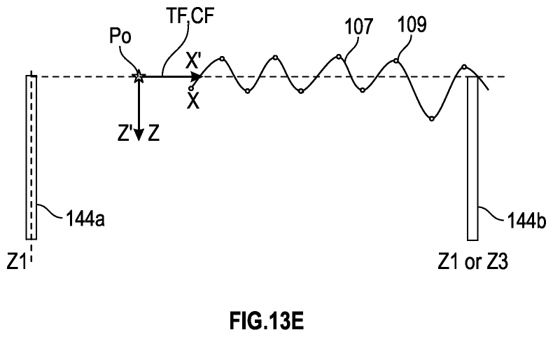

In the illustrated aspect, the method 400 includes, at block 402, performing a number of measurements of position Dz across the build surface 107 as described above. The measurements of position Dz may be randomly across the build surface 107 or in patterns across the build surface 107, such as according to the example of a pattern illustrated in FIG. 9. In the illustrated aspect, both the leveling and topographic compensation measurements of position Dz are taken at the same time. It should be appreciated that in taking this data at the same time, the amount of time for resolving the leveling and topographic compensation data may be reduced. FIG. 13a illustrates the relative values of the measurements of position Dz taken at various points 109 across the build surface 107 before the build surface 107 is leveled.

At block 404, the measurements of position Dz taken at a few of the points 109, such as the points illustrated in FIGS. 8a and 8b, are selected for fitting an x, y-plane 138 to the build surface 107 using, for example, least squares fitting of the measurements of position Dz. In aspects, three or more and up to N number of measurements of position Dz, including all values and ranges therein such as from 3 to 10 measurements of position Dz, are used to fit the x,y-plane 138. In addition, a point of origin Po of the coordinate frame CF is identified as noted above. The known x, y-distance XYD from the point of origin Po to the primary z-axis linear adjustment drive 144a is determined as illustrated in FIG. 13b.

At block 406, the offsets Z2/3 for leveling the build surface 107 by adjusting the z-axis linear adjustment drives 144, and particularly the secondary z-axis linear adjustment drives 144b, are calculated. At block 408, the offsets Z2/3 are applied to the z-axis linear adjustment drives 144. At block 410, the transforms for the dataset are created and, at block 412, the transforms are applied to the dataset. In alternative aspects, the offsets Z2/3 to the z-axis linear adjustment drives 144 may be applied after the transforms for the dataset are created at block 410 or after the transform is applied at block 412. In applying the transforms, the x, y-plane of the coordinate frame CF is rotated to be co-planar with the x, y-plane 138 of the build surface 107 resulting in transformed frame TF, as illustrated in FIG. 13c and the coordinate frame is translated along the local x-axis to the point of origin Po of the printer frame as illustrated in FIG. 13d.

At block 414, transforming the measurements of position Dz in block 412 results in the creation of a topographic compensation map that is stored is memory 184. In aspects, the same transforms are applied to the measurements of position Dz performed for both print heads 112. At block 416, one of two print heads 112 is selected for printing, then at block 418, the topographic compensation map associated with the selected print head 112 is applied during the printing process to maintain a consistent distance in the z-axis 20 between the extrusion nozzle 170 and the build surface 107 consistent during printing. If two print heads 112 are selected for printing, then at block 418, the topographic compensation maps associated with the print heads 112 may be averaged to accommodate for both print heads. FIG. 13e illustrates the build surface after it has been leveled and the transforms have been applied to the measurements of position Dz performed at the points 109.

The system and methods of the present disclosure offers several advantages. These advantages include the leveling of a support bed and mapping of a support bed to improve print quality of three-dimensional printed objects. These advantages further include the ability to select a topographic map appropriate for a given printer head in a multiple printer head system. These advantages further include a relative reduction in the time to leveling and mapping over previous processes.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of compensating for build surface topography, comprising:
measuring a position of a build surface in a z-axis at each point in a first set of points on the build surface when the build surface is pressed against a first fixed point on a first print head;
fitting an x, y-plane to the first set of points on the build surface;
leveling the build surface by rotating the x, y-plane around a point of origin in the z-axis;
creating a first topographic compensation map based on a second set of points on the build surface; and
adjusting a distance between the first fixed point on the first print head and the build surface during printing referencing the first topographic compensation map.

2. The method of claim 1, wherein measuring comprises raising the build surface until the build surface touches a first extrusion nozzle in the first print head at each of the points in the first set of points on the build surface; raising the first extrusion nozzle to contact a first sensor placed on the first print head; and measuring the position (Dz) of the build surface in the z-axis relative to a starting point in the z-axis.

3. The method of claim 2, wherein the build surface is supported by a z-axis gantry connected to a z-axis linear adjustment drive and leveling comprises calculating an offset for the z-axis linear adjustment drive and applying the offset to the z-axis linear adjustment drive.

4. The method of claim 3, wherein the z-axis gantry is connected to three z-axis linear adjustment drives and leveling comprises calculating an offset for each of the three z-axis linear adjustment drives.

5. The method of claim 4, further comprising repeating measuring and leveling until each of the offsets for the z-axis linear adjustment drives is under a threshold.

6. The method of claim 1, wherein creating the first topographic compensation map further comprises measuring the position of the build surface in the z-axis at each of the second set of points on the build surface when the build surface is pressed against a first fixed point on the first print head.

7. The method of claim 6, wherein measuring further comprises raising the build surface until the build surface touches a first extrusion nozzle in the first print head at each of the points in the second set of points on the build surface; raising the first extrusion nozzle to contact a first sensor; and measuring the position (Dz) of the build surface in the z-axis relative to a starting point in the z-axis.

8. The method of claim 6, wherein the second set of points includes the first set of points.

9. The method of claim 1, further comprising creating a second topographic compensation map for a second print head.

10. The method of claim 9, wherein creating the second topographic compensation map further comprises measuring a position of the build surface in the z-axis at the second set of points on the build surface when the build surface is pressed against a second fixed point on the second print head.

11. A three-dimensional printer, comprising:
a controller, wherein the controller includes executable code to:
measure a position of a build surface in a z-axis at each point in a first set of points on the build surface when the build surface is pressed against a fixed point on a first print head;
fit an x, y-plane to the first set of points on the build surface;
level the build surface by rotating the x, y-plane around a point of origin in the z-axis;
create a first topographic compensation map based on a second set of points on the build surface; and
adjust a distance between the fixed point on the first print head and the build surface during printing referencing the first topographic compensation map.

12. The three-dimensional printer of claim 11, wherein to measure the position of the build surface in the z-axis at each point in the first set of points on the build surface, the controller includes executable code to:
raise the build surface until the build surface touches a first extrusion nozzle in the first print head at each of the points in the first set of points on the build surface;
raise the first extrusion nozzle to contact a first sensor placed on the first print head; and
measure the position (Dz) of the build surface in the z-axis relative to a starting point in the z-axis.

13. The three-dimensional printer of claim 12, wherein the build surface is supported by a z-axis gantry connected to a z-axis linear adjustment drive and to level the build surface the controller includes executable code to:
calculate an offset for the z-axis linear adjustment drive; and
apply the offset to the z-axis linear adjustment drive.

14. The three-dimensional printer of claim 13, wherein the z-axis gantry is connected to three z-axis linear adjustment drives and to level the build surface the controller includes executable code to calculate an offset for each of the three z-axis linear adjustment drives.

15. The three-dimensional printer of claim 14, wherein the controller includes further executable code to repeat measuring the position of the build surface in the z-axis at each point in the first set of points on the build surface and leveling the build surface until each offset for the z-axis linear adjustment drives is under a threshold.

16. The three-dimensional printer of claim 11, wherein to create the first topographic compensation map the controller includes executable code to measure the position of the build surface in the z-axis at each of the second set of points on the build surface when the build surface is pressed against a first fixed point on the first print head.

17. The three-dimensional printer of claim 16, wherein to measure the position of the build surface in the z-axis at each of the second set of points on the build surface, the controller includes executable code to:
raise the build surface until the build surface touches a first extrusion nozzle in the first print head at each of the points in the second set of points on the build surface;
raise the first extrusion nozzle to contact a first sensor; and
measure the position (Dz) of the build surface in the z-axis relative to a starting point in the z-axis.

18. The three-dimensional printer of claim 16, wherein the second set of points includes the first set of points.

19. The three-dimensional printer of claim 11, the controller includes further executable code to create a second topographic compensation map for a second print head.

20. The three-dimensional printer of claim 19, wherein to create the second topographic compensation map the controller includes instructions to measure a position of the build surface in the z-axis at the second set of points on the build surface when the build surface is pressed against a second fixed point on the second print head.
